(19) United States
(12) Patent Application Publication
(10) Pub. No.: US 2026/0228474 A1
(43) Pub. Date: Aug. 6, 2026

(54) PRINTING DEVICE

(71) Applicant: SEIKO EPSON CORPORATION, Tokyo (JP)

(72) Inventor: Hideyuki KATAOKA, MATSUMOTO-SHI (JP)

(21) Appl. No.: 19/460,822

(22) Filed: Jan. 27, 2026

(30) Foreign Application Priority Data
Jan. 31, 2025 (JP) 2025-014791

(51) Int. Cl. G06K 15/00

(52) U.S. Cl. CPC G06K 15/005

(57) ABSTRACT

A printing device includes a display unit that is displaceable between a first position where a rear surface is accommodated in an accommodation part and a second position where the rear surface is exposed from the accommodation part, and the display unit includes therein a display panel having a display surface facing a side opposite to a direction in which the rear surface faces, and a sound output unit that is disposed close to the rear surface than the display panel and outputs a predetermined sound, and an output direction of the predetermined sound output from the sound output unit is a direction toward the display surface.

The present application is based on, and claims priority from JP Application Serial Number 2025-014791, filed January 31, 2025, the disclosure of which is hereby incorporated by reference herein in its entirety.

### BACKGROUND

### 1. Technical Field

The present disclosure relates to a printing device.

### 2. Related Art

JP-A-2020-116779 discloses an image forming device including an operation panel that has a display unit and a speaker arranged beside the display unit.

FIGS. 5 to 8 of JP-A-2021-87077 disclose an image forming device including a speaker that emits sound toward the back side of an operation device including a liquid crystal panel, at the back side of the liquid crystal panel.

JP-A-2024-106463 discloses an electronic device including an operation unit that can be stored in a storage unit by a tilt mechanism.

JP-A-2020-116779, JP-A-2021-87077, and JP-A-2024-106463 are examples of the related art.

In the image forming device described in JP-A-2020-116779, since the display unit and the speaker are arranged side by side, the screen size of the display unit is limited. Meanwhile, when the speaker is disposed at the back side of the liquid crystal panel as in the configuration described in JP-A-2021-87077, the screen size can be further increased and therefore usability is improved. However, when the configuration of JP-A-2021-87077, in which sound is emitted toward the back side, is applied to the operation unit disclosed in JP-A-2024 -106463, the sound tends to be confined in the storage unit. Thus, the sound emitted from the speaker is reduced and the sound may be hard for the user to hear. When it is hard to hear the sound emitted from the speaker, the user may need to perform an operation of raising the operation unit from the storage unit, using the tilt mechanism, and this may lead to a decrease in usability.

### SUMMARY

According to an aspect of the present disclosure, a printing device includes: a printing unit configured to perform printing on a medium; a first housing including an accommodation part at a first surface and configured to cover the printing unit; and a display unit configured to be displaceable between a first position where a rear surface is accommodated in the accommodation part and a second position where the rear surface is exposed from the accommodation part, in which the display unit includes therein a display panel having a display surface facing a side opposite to a direction in which the rear surface faces, and a sound output unit disposed closer to the rear surface than the display panel and configured to output a predetermined sound, and an output direction of the predetermined sound output from the sound output unit is a direction toward the display surface.

### BRIEF DESCRIPTION OF THE DRAWINGS

FIG. 1 is a side view schematically showing a printing device.

FIG. 2 is a perspective view schematically showing an accommodated state of a display unit.

FIG. 3 is a perspective view schematically showing an exposed state of the display unit.

FIG. 4 is a front view of the display unit.

FIG. 5 is an exploded perspective view of the display unit.

### DESCRIPTION OF EMBODIMENTS

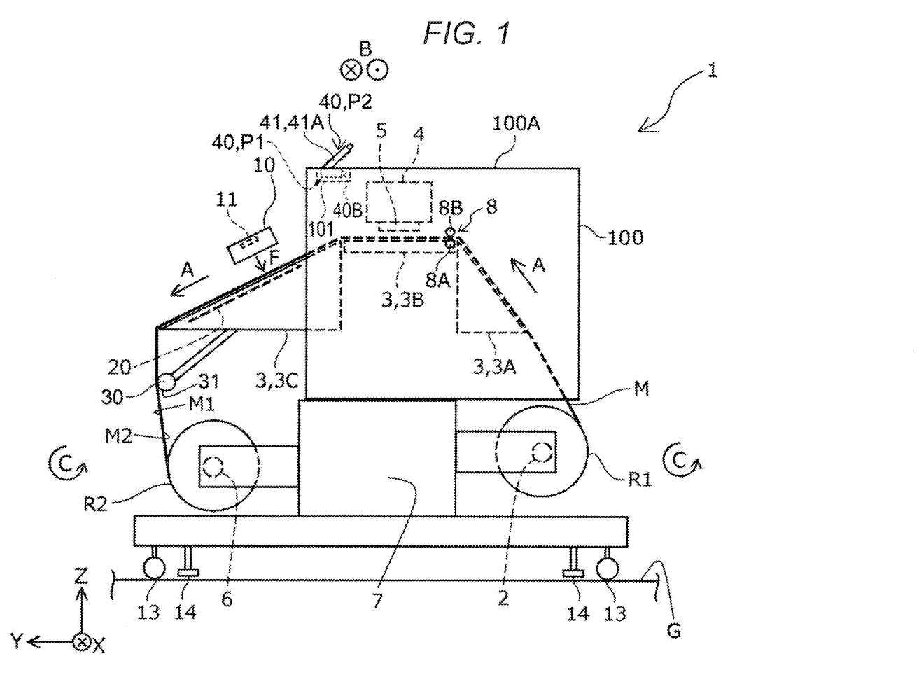

Hereinafter, a printing device 1 according to the present embodiment will be described with reference to the drawings. The printing device 1 illustrated in FIG. 1 is, for example, an inkjet printer that ejects an ink, which is an example of a "liquid", to a conveyed medium M, and thus records an image such as a character or a photograph on the medium M.

In the drawings below, individual members are not to scale in order to show these members in recognizable sizes. In the drawings, the same components are denoted by the same reference numerals, and a repeated description thereof is omitted. Also, in each drawing, an X axis, a Y axis, and a Z axis are illustrated as necessary, as coordinate axes orthogonal to each other. Arrows are attached to the X axis, the Y axis, and the Z axis, respectively. Along each of the X axis, the Y axis, and the Z axis, the direction of the arrow is a positive direction, and the direction opposite to the direction of the arrow is a negative direction.

Hereinafter, for the sale of convenience of description, the positive direction along the X axis may be referred to as a left direction or simply the left, and the negative direction may be referred to as a right direction or simply the right. Also, the positive direction along the Y axis may be referred to as a front direction or simply the front, and the negative direction may be referred to as a rear direction or simply the rear. Also, the positive direction along the Z axis may be referred to as an upward direction or simply up or above, and the negative direction may be referred to as a downward direction or simply down or below.

A direction parallel to the X axis is the width direction of the printing device 1 and corresponds to the width direction of the medium M on which an image is recorded. A direction parallel to the Y axis corresponds to the depth direction of the printing device 1.

As illustrated in FIG. 1, the printing device 1 according to the present embodiment includes a first housing 100. A leg frame 7 is attached to parts near the two ends of the first housing 100 along the X axis. A caster 13 and an adjuster 14 are provided below the leg frame 7. The caster 13 is used to move the printing device 1. The adjuster 14 is used to suitably install the printing device 1 at an installation surface G. The printing device 1 includes a supply unit 2 that holds a roll body R1 on the -Y direction side, which is the rear direction, of the first housing 100. The supply unit 2 supports a paper tube of the roll body R1 formed of the wound medium M so as to sandwich the paper tube in a direction along the X axis, and supplies the medium M to a position facing a head 5.

The first housing 100 has an accommodation part 101 at an upper surface 100A, which is a surface facing the +Z direction. The upper surface 100A is an example of a "first surface". The upper surface 100A is on an XY plane parallel to the X axis and the Y axis. The accommodation part 101 is provided in a recessed shape recessed in the -Z direction from the upper surface 100A of the first housing 100.

The printing device 1 includes a display unit 40. The display unit 40 is accommodated in the accommodation part 101. The display unit 40 includes a display panel 41 that displays information such as text and graphic shapes. The display panel 41 has a display surface 41A facing a side opposite to the direction in which a rear surface 40B of the display unit 40 faces. The display unit 40 is displaceable to a first position P1 where the display surface 41A of the display panel 41 faces in a first direction, which is to the outside of the first housing 100, and is thus accommodated in the accommodation part 101, by a tilt mechanism, not illustrated, that is provided in the printing device 1. Also, the display unit 40 is displaceable to a second position P2 where the display surface 41A stands up from the accommodation part 101 so as to face in a second direction intersecting the first direction. The first direction is, for example, the +Z direction, and the second direction is an oblique direction having a vector component in the +Z direction and a vector component in the +Y direction. The posture of the display unit 40 can be fixed at any position between the first position P1 and the second position P2 by the tilt mechanism.

In other words, the display unit 40 is displaceable between the first position P1, where the rear surface 40B of the display unit 40 is accommodated in the accommodation part 101, and the second position P2, where the rear surface 40B of the display unit 40 is exposed from the accommodation part 101. The display unit 40 will be described later in detail.

When the printing device 1 conveys the medium M in a conveyance direction A, the supply unit 2 rotates the roll body R1 in a rotation direction C. In FIG. 1, the roll body R1 formed of the medium wound such that an image forming surface M1 on which an image is formed is on the outer side is used, but the roll body R1 formed of the medium wound such that the image forming surface M1 is on the inner side can also be used. In this case, the supply unit 2 can feed the medium M by rotating the roll body R1 in a direction opposite to the rotation direction C.

Also, the printing device 1 includes a conveyance path of the medium M including a medium support unit 3 that supports the medium M, and the like. The printing device 1 includes, as the medium support unit 3, an upstream medium support unit 3A, a platen 3B, and a downstream medium support unit 3C in this order from upstream to downstream in the conveyance direction A.

Also, the printing device 1 includes a roller pair 8 including a drive roller 8A and a driven roller 8B for conveying the medium M in the conveyance direction A through the conveyance path. The drive roller 8A and the driven roller 8B may be reversed in the drive-driven relationship.

Also, the printing device 1 includes the head 5 having a nozzle, not illustrated, at a position in the +Z direction facing the platen 3B, and ejecting an ink from the nozzle, and a carriage 4 in which the head 5 is mounted and which can move forward and backward in a width direction B. The head 5 is an example of a "printing unit" that performs printing on the medium M. A liquid supply path, not illustrated, including a tube or the like is coupled to the head 5, and an ink is supplied to the head 5 from an ink cartridge, not illustrated, via the liquid supply path. In the printing device 1 according to the present embodiment, at the position where the platen 3B and the head 5 face each other, the conveyance direction A is the +Y direction, the width direction B, which is the direction of movement of the head 5, is a direction along the X axis, and the direction of ink ejection is the -Z direction. In the present embodiment, the first housing 100 covers at least the head 5. In the present embodiment, the first housing 100 also covers the upstream medium support unit 3A, the platen 3B, and a part of the downstream medium support unit 3C.

The printing device 1 repeats the conveyance of the medium M in the conveyance direction A by a predetermined amount of conveyance and the ejection of the ink while moving the head 5 in the width direction B in a state where the medium M is stopped. However, the printing device 1 is not limited to the configuration described above and may have a configuration including a so-called line head in which nozzles ejecting the ink are arranged along the width direction B over the entire width of the medium M, or a configuration including a thermal transfer-type printing unit.

The downstream medium support unit 3C is provided with a heater 20 that heats a supported surface M2 of the medium M opposite to the image forming surface M1. The heater 20 is configured with an electrically heated wire or the like, but is not limited to such a configuration. For example, in order to heat the supported surface M2 opposite to the image forming surface M1 of the medium M, the heater 20 may be provided not only in the downstream medium support unit 3C but also in the upstream medium support unit 3A and the platen 3B.

Also, an air blowing unit 10 that dries the ink ejected from the head 5 to the image forming surface M1 of the medium M by blowing an air flow F thereto is provided at a part facing the downstream medium support unit 3C in the conveyance path. The air blowing unit 10 in the present embodiment includes a fan 11 that generates the air flow F, and is configured to blow a gas as the air flow F to the image forming surface M1 of the medium M, but is not limited to such a configuration.

A take-up unit 6 that winds up the medium M conveyed in the conveyance direction A into a roll shape to form a roll body R2 is provided downstream of the downstream medium support unit 3C in the conveyance direction A. The medium M conveyed from the supply unit 2 to the take-up unit 6 is conveyed in a state where a predetermined tension is applied thereto, in the conveyance path. The take-up unit 6 supports the paper tube, which is the winding core of the roll body R2, so as to sandwich the paper tube in a direction along the X axis, and rotates the paper tube and thus winds up the medium M into a roll shape. In FIG. 1, the take-up unit 6 rotates the roll body R2 in the rotation direction C and thus winds the medium M such that the image forming surface M1 is on the outer side, but the take-up unit 6 may wind up the medium M such that the image forming surface M1 is on the inner side. In this case, the take-up unit 6 rotates the roll body R2 in the direction opposite to the rotation direction C.

A guide bar 30 is provided between the downstream medium support unit 3C and the take-up unit 6 in the conveyance direction A. The guide bar 30 has an arc-shaped contact surface 31 when viewed from the width direction B. The guide bar 30 guides the conveyance of the medium M as the contact surface 31 comes into contact with the supported surface M2 of the medium M wound up by the take-up unit 6. However, the configuration of the guide bar 30 is not particularly limited, and a configuration without having the guide bar 30 may be employed.

The printing device 1 includes a control unit, not illustrated. The control unit controls various operations of the printing device 1. The configuration of the control unit is not particularly limited, and the control unit may be an external device such as a computer that can communicate with the printing device 1.

The printing device 1 having the above-described configuration can record an image such as a character or a photograph on the medium M by ejecting an ink onto the conveyed medium M.

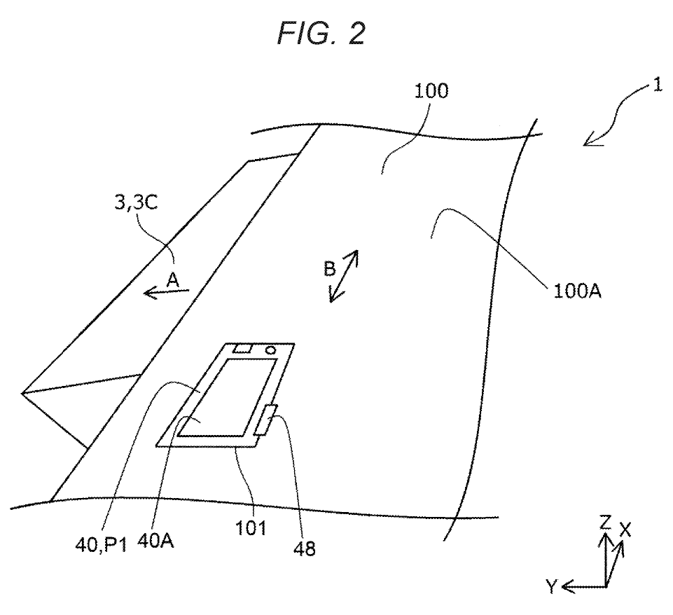

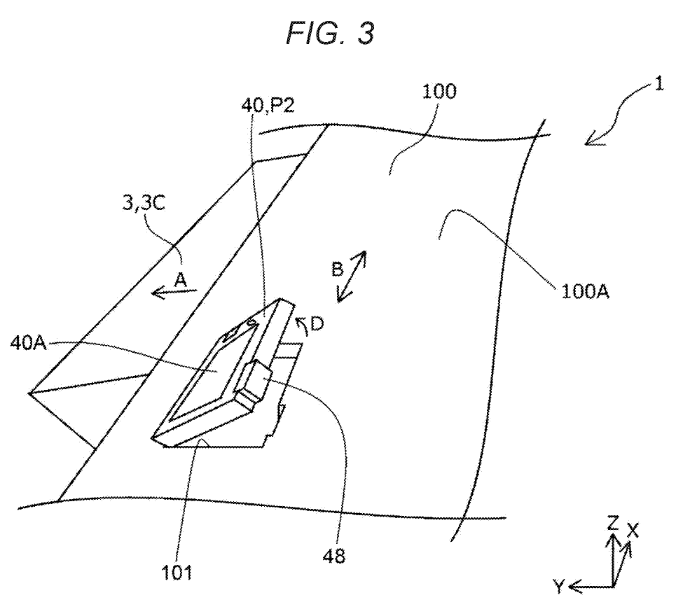

Hereinafter, a state where the display unit 40 is accommodated in or exposed from the accommodation part 101 will be described with reference to FIGS. 2 and 3.

FIG. 2 illustrates a state where the display unit 40 is displaced to the first position P1 via the tilt mechanism, not illustrated, that is provided in the printing device 1. The display unit 40 is accommodated in the accommodation part 101 with a front surface 40A of the display unit 40 facing in the +Z direction. The display unit 40 includes an indication lamp 48 that indicates a control state of the printing device 1 by emitting light. The surface of the display unit 40 facing in the +Z direction and the surface of the indication lamp 48 facing in the +Z direction are accommodated so as to be substantially flush with the upper surface 100A of the first housing 100.

FIG. 3 illustrates a state where the display unit 40 is displaced to the second position P2 via the tilt mechanism, not illustrated, that is provided in the printing device 1. By pivotally moving in a displacement direction D, the display unit 40 is exposed to the outside from the accommodation part 101 so that the front surface 40A of the display unit 40 is in a state of being visible when viewed in the -Y direction from the +Y direction. When the display unit 40 is displaced to the second position P2, the indication lamp 48 can be visible from all of the front, rear, left, and right directions of the printing device 1.

The display unit 40 illustrated in FIG. 3 is in a state of being pivotally moved by about 45° in relation to the upper surface 100A of the first housing 100. In the state where the display unit 40 is at the second position P2 illustrated in FIG. 3, the direction in which the front surface 40A faces is a direction having a vector component in the +Z direction and a vector component in the +Y direction. However, since the display unit 40 can be pivotally moved by 90° or more in relation to the upper surface 100A, the direction in which the front surface 40A faces is not limited thereto. For example, the direction in which the front surface 40A faces may be the +Y direction, which corresponds to a state where the display unit 40 is pivotally moved by 90°. Moreover, the direction in which the front surface 40A faces may be a direction having a vector component in the -Z direction and a vector component in the +Y direction, which corresponds to a state where the display unit 40 is pivotally moved by more than 90°. That is, the direction in which the front surface 40A faces may be any direction having a vector component in the +Y direction.

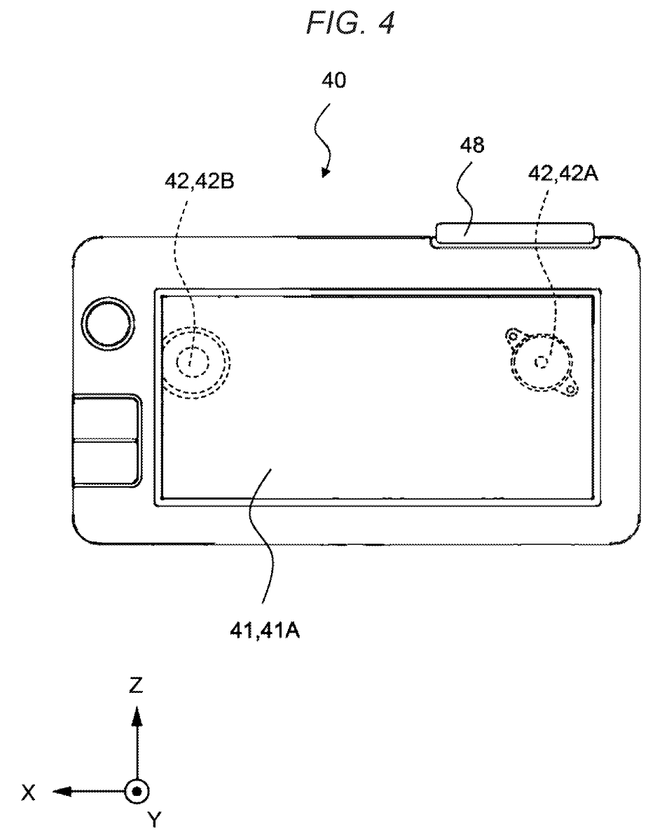

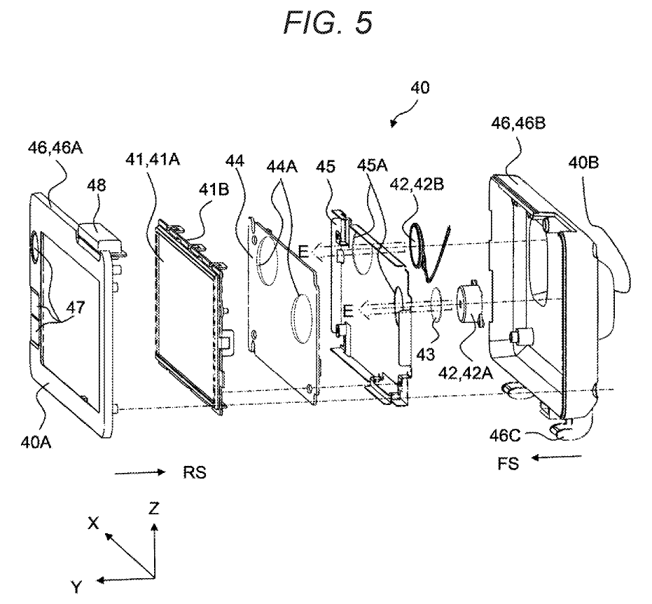

Hereinafter, the display unit 40 will be described in detail with reference to FIGS. 4 and 5. FIGS. 4 and 5 illustrate the state where the display unit 40 is pivotally moved by about 90° in relation to the upper surface 100A (see FIG. 3). In FIG. 5, the side on which the front surface 40A is located when viewed from the position of the rear surface 40B of the display unit 40 is illustrated as a front surface side FS, and the side on which the rear surface 40B is located when viewed from the position of the front surface 40A of the display unit 40 is illustrated as a rear surface side RS.

As illustrated in FIG. 4, the display unit 40 further includes a sound output unit 42. The sound output unit 42 includes a buzzer 42A and a speaker 42B. In the illustration of FIG. 4, the sound output unit 42 is disposed, overlapping the display surface 41A of the display panel 41, and is disposed more in the -Y direction than the display panel 41. As the sound output unit 42 is arranged in relation to the display panel 41 in this way, the display screen size of the display unit 40 can be further increased and usability based on visibility can be improved.

As illustrated in FIG. 5, the display unit 40 includes a sheet member 43, a substrate 44, and a metal plate 45 in addition to the display panel 41 and the sound output unit 42. The display unit 40 further includes an operation button 47 for inputting a predetermined instruction necessary for controlling the printing device 1, the indication lamp 48 for indicating a control state of the printing device 1 by emitting light, and a second housing 46 that is an exterior of the display unit 40. The second housing 46 includes a front case 46A and a rear case 46B. The second housing 46 accommodates the display panel 41, the sound output unit 42, the sheet member 43, the substrate 44, and the metal plate 45.

The display panel 41, the operation button 47, and the indication lamp 48 are disposed in the front case 46A. The display panel 41 is housed in the second housing 46 such that the display surface 41A faces to the outside of the second housing 46. The display panel 41 displays predetermined information necessary for controlling the printing device 1 on the display surface 41A of the display panel 41. Examples of the display panel 41 include a liquid crystal display and the like. A touch panel-type operation panel that can input an operation instruction to the printing device 1 corresponding to a predetermined operation instruction button image displayed on the display surface 41A may be provided to the front surface side FS of the display surface 41A of the display panel 41.

The substrate 44 is disposed to the rear surface side RS of the display panel 41. The substrate 44 is a circuit board that implements the function of the display unit 40, under the control of the control unit. A plurality of through holes 44A are formed in the substrate 44. The metal plate 45 is disposed to the rear surface side RS of the substrate 44. The metal plate 45 is a shield member that protects the substrate 44 from electrical noise. A plurality of through holes 45A are formed in the metal plate 45.

When the display surface 41A of the display panel 41 is viewed from a direction perpendicular to the display surface 41A, the sound output unit 42 is accommodated inside the second housing 46 so as to be located to the rear surface side RS of the display panel 41 in the display unit 40 and to overlap the display surface 41A of the display panel 41. In other words, the sound output unit 42 is disposed closer to the rear surface side RS than the display panel 41.

The buzzer 42A and the speaker 42B provided in the sound output unit 42 are disposed in the rear case 46B. Although a small opening penetrating the rear case 46B from the front surface side FS toward the rear surface 40B is formed in the rear case 46B, the configuration of the rear case 46B is not limited thereto, and a small opening may not be formed in the rear case 46B. The buzzer 42A is disposed corresponding to each of the through hole 44A formed in the substrate 44 and the through hole 45A formed in the metal plate 45. Also, the speaker 42B is disposed corresponding to each of the through hole 44A formed in the substrate 44 and the through hole 45A formed in the metal plate 45.

The sound output unit 42 including the buzzer 42A and the speaker 42B outputs a predetermined sound, based on the control state of the printing device 1. An output direction E of the predetermined sound output from the sound output unit 42 is a direction toward the display surface 41A. With such a configuration, the predetermined sound output from the buzzer 42A and the speaker 42B propagates in a direction toward the display surface 41A through the air in the second housing 46 and media such as the display panel 41 and the front case 46A.

The buzzer 42A vibrates a diaphragm provided in the buzzer 42A at a specific frequency and thus outputs a sound. The speaker 42B converts an electric signal for changing a sound into vibration of air and thus outputs a sound. In the present embodiment, the buzzer 42A and the speaker 42B have different volumes of sounds that can be output. The volume of the sound output from the buzzer 42A is larger than the volume of the sound output from the speaker 42B.

The buzzer 42A can output a single sound having a volume larger than that of the speaker 42B and thus can notify the user of a control state of the printing device 1. Meanwhile, the speaker 42B can output at least one type of melody and thus can notify the user of a control state of the printing device 1 that is different from the control state of when the buzzer 42A outputs a sound. In the present embodiment, the speaker 42B outputs sounds having two different types of volumes, but the volume of the output sound may be one type.

The sheet member 43 is provided between the display panel 41 and the buzzer 42A. In the present embodiment, the sheet member 43 is provided at a surface of the buzzer 42A facing the front surface side FS. The sheet member 43 is a porous member. The porous member may be a so-called sponge-like member in which pores of irregular shapes continues irregularly to penetrate the member, or may be a member in which pores of irregular shapes are formed irregularly and independently of each other without penetrating the member. However, the sheet member 43 is not limited to a porous member. The sheet member 43 may be, for example, a tape-shaped soft member having no porosity or a plate-shaped soft member having no porosity.

A single sound with a large volume output from the buzzer 42A in the output direction E is diffused by the sheet member 43. When the sheet member 43 is not provided, a single sound having a large volume output from the buzzer 42A may be reflected by a back surface 41B of the display panel 41 and return to the diaphragm of the buzzer 42A. This may disturb the vibration of the diaphragm of the buzzer 42A and modulate the sound output from the buzzer 42A. In particular, in the buzzer 42A outputting a single sound with a large volume, sound modulation tends to easily occur.

In the present embodiment, since the sheet member 43 is provided at the surface of the buzzer 42A facing the front surface side FS, the sound output from the buzzer 42A can be diffused at the position closest to the diaphragm of the buzzer 42A. Thus, the single sound reflected by the back surface 41B of the display panel 41 and returning to the diaphragm of the buzzer 42A is suppressed, and therefore the occurrence of the modulation of the sound output from the buzzer 42A can be effectively suppressed.

The rear case 46B has a hinge 46C. The hinge 46C is a part of the tilt mechanism and is a pivot shaft that can displace the display unit 40 to the first position P1 and the second position P2. The display unit 40 is coupled to a main part of the tilt mechanism, not shown, via the hinge 46C or the like.

The operation button 47 is a power button, another function button, or the like. The operation button 47 includes a push button, a touch sensor, or the like, but is not limited thereto. The indication lamp 48 includes a light-emitting diode (LED) or the like, but is not limited thereto. The indication lamp 48 can display the control state of the printing device 1 by changing the lighting state.

As described above, the printing device 1 according to the present embodiment can achieve the following effects. The printing device 1 according to the present embodiment includes the head 5, which performs printing on the medium M. The printing device 1 further includes the first housing 100 having the accommodation part 101 at the upper surface 100A and covering the head 5, and the display unit 40, which is displaceable between the first position P1, where the rear surface 40B is accommodated in the accommodation part 101, and the second position P2, where the rear surface 40B is exposed from the accommodation part 101. The display unit 40 includes therein the display panel 41 having the display surface 41A facing the side opposite to the direction in which the rear surface 40B faces, and the sound output unit 42 disposed to the rear surface side RS of the display panel 41 and outputting a predetermined sound. The output direction E of the predetermined sound output from the sound output unit 42 is a direction toward the display surface 41A.

According to the present embodiment, since the output direction E of the predetermined sound output from the sound output unit 42 is a direction toward the display surface 41A, the sound heard by the user is less likely to be small than when the output direction E of the sound output from the sound output unit 42 is a direction toward the rear surface 40B. That is, the difference in the volume of the sound heard by the user between when the display unit 40 is displaced to the first position P1 and when the display unit 40 is displaced to the second position P2 can be reduced. Thus, the user can easily hear the sound regardless of the position to which the display unit 40 is displaced, and therefore an operation of exposing the rear surface 40B of the display unit 40 such as raising the display unit 40 is not necessary and a decrease in usability can be suppressed.

Also, according to the present embodiment, the display unit 40 includes the sheet member 43 between the display panel 41 and the buzzer 42A. Thus, the occurrence of sound modulation between the display panel 41 and the buzzer 42A can be suppressed.

Also, according to the present embodiment, since the sheet member 43 is a porous member, the occurrence of sound modulation between the display panel 41 and the buzzer 42A can be effectively suppressed.

While an embodiment has been described in detail above with reference to the drawings, the specific configurations are not limited to the embodiment and may be changed, replaced, deleted or the like without departing from the scope of the present disclosure. Also, other embodiments given below may be employed. The other embodiments can achieve the same effects as those of the above embodiment.

In the above-described embodiment, the first housing 100 includes the accommodation part 101 at the upper surface 100A, which is the surface on the +Z direction side, but the present disclosure is not limited thereto. For example, the first housing 100 may include the accommodation part 101 at a side surface that is a surface intersecting the X axis or a side surface that is a surface intersecting the Y axis, of the first housing 100. In this case, the side surface is an example of the "first surface". When the accommodation part 101 is provided at the side surface of the first housing 100, the first direction is a direction in which the side surface faces.

In the above embodiment, the sheet member 43 is provided between the display panel 41 and the buzzer 42A, but may also be provided between the display panel 41 and the speaker 42B.

In the above embodiment, the sheet member 43 is provided between the display panel 41 and the buzzer 42A in order to suppress the occurrence of sound modulation, but the sheet member 43 may not be provided. For example, the occurrence of sound modulation can also be suppressed by outputting a predetermined sound from the buzzer 42A in a direction intersecting a normal line to the back surface 41B of the display panel 41 with a vector component in the +Y direction in FIG. 5. Alternatively, the occurrence of sound modulation can also be suppressed by increasing the distance between the back surface 41B of the display panel 41 and the surface of the buzzer 42A facing the front surface side FS. In this case, the distance between the back surface 41B of the display panel 41 and the surface of the buzzer 42A facing the front surface side FS is, for example, 5.7 mm or more.

In the above embodiment, the output direction E of the predetermined sound output from the speaker 42B is a direction toward the display surface 41A similarly to the buzzer 42A, but is not limited thereto. For example, the buzzer 42A and the speaker 42B may output sounds in different directions. In this case, the predetermined sound output from the speaker 42B may be output in a direction toward the rear surface 40B. The reason for this is that the melody output from the speaker 42B is easy to hear regardless of the position to which the display unit 40 is displaced. This also eliminates the need for an operation of exposing the rear surface 40B of the display unit 40, such as raising the display unit 40, and can suppress a decrease in usability.

Although the through hole 44A is formed in the substrate 44 in the above embodiment, the present disclosure is not limited thereto, and the through-hole 44A may not be formed in the substrate 44. In this case, the above-described relationship between the display panel 41 and the buzzer 42A in terms of the sound reflection, the separation distance, and the facing angle is replaced with the relationship between the substrate 44 and the buzzer 42A.

In the above-described embodiment, the through hole 45A is formed in the metal plate 45, but the present disclosure is not limited thereto, and the through hole 45A may not be formed in the metal plate 45. In this case, the above-described relationship between the display panel 41 and the buzzer 42A is replaced with the relationship between the metal plate 45 and the buzzer 42A.

In the above embodiment, the substrate 44 and the metal plate 45 are disposed between the display panel 41 and the sound output unit 42, but the present disclosure is not limited thereto. For example, the substrate 44 and the metal plate 45 may be disposed at a location other than between the display panel 41 and the sound output unit 42, or may be disposed at a location where the substrate 44 and the metal plate 45 do not overlap the sound output unit 42 when the rear surface side RS is viewed from a direction perpendicular to the display surface 41A.

In the above embodiment, the sheet member 43 is provided at the surface of the buzzer 42A facing the front surface side FS, but is not limited thereto. For example, the sheet member 43 may be provided at a position facing the buzzer 42A in any of the display panel 41, the substrate 44, and the metal plate 45. Thus, since the surface of the buzzer 42A facing the front surface side FS is not blocked by the sheet member 43, most of the sound output from the buzzer 42A can be output in the direction toward the display surface 41A, and the occurrence of sound modulation can be suppressed.

What is claimed is:

1. A printing device comprising:
a printing unit configured to perform printing on a medium;
a first housing including an accommodation part at a first surface and configured to cover the printing unit; and
a display unit configured to be displaceable between a first position where a rear surface is accommodated in the accommodation part and a second position where the rear surface is exposed from the accommodation part, wherein
the display unit includes therein
a display panel having a display surface facing a side opposite to a direction in which the rear surface faces, and
a sound output unit disposed closer to the rear surface than the display panel is and configured to output a predetermined sound, and
an output direction of the predetermined sound output from the sound output unit is a direction toward the display surface.

2. The printing device according to claim 1, wherein
the sound output unit is a speaker that converts an electric signal into vibration of air and thus outputs a sound.

3. The printing device according to claim 1, wherein
the sound output unit is a buzzer that vibrates a diaphragm at a specific frequency and thus outputs a sound.

4. The printing device according to claim 1, wherein
the sound output unit includes a speaker that converts an electric signal into vibration of air and thus outputs a sound, and a buzzer that vibrates a diaphragm at a specific frequency and thus outputs a sound.

5. The printing device according to claim 3, wherein
the display unit includes a sheet member between the display panel and the buzzer.

6. The printing device according to claim 5, wherein
the sheet member is a porous member.

7. The printing device according to claim 4, wherein
the buzzer and the speaker have different volumes of sound that can be output.
